(19) United States
(12) Patent Application Publication
(10) Pub. No.: US 2012/0293563 A1
(43) Pub. Date: Nov. 22, 2012

(54) DISPLAY DEVICE

(76) Inventors: Hajime Akimoto, Kokubunji (JP); Kenta Kajiyama, Yotsukaido (JP)

(21) Appl. No.: 13/470,424

(22) Filed: May 14, 2012

(30) Foreign Application Priority Data
May 16, 2011 (JP) 2011-109735

(51) Int. Cl. G09G 3/36; G09G 5/10

(52) U.S. Cl. 345/690; 345/87

(57) ABSTRACT

A display device which includes a light source which independently emits light of three colors of RGB, and an emission control unit which controls the light source to continuously emit one of principal wavelength light beams of three RGB light beams in each of the sub-frames, in which the emission control unit controls a Green light as one of the plural principal wavelengths among light beams of three RGB colors to be emitted in the sub-frame which is arranged at the same position in the one frame period of both an odd frame as the odd numbered single frame period and an even frame as the even numbered single frame period, and controls light of the R color and the B color to be emitted in different sub-frames between the odd frames and the even frames.

### CROSS-REFERENCE TO RELATED APPLICATION

The present application claims priority from Japanese application JP2011-109735 filed on May 16, 2011, the content of which is hereby incorporated by reference into this application.

### BACKGROUND OF THE INVENTION

1. Field of the Invention

The present invention relates to a display device, more specifically relates to a display device which performs a display using a field sequential method.

2. Description of the Related Art

A liquid crystal display device displays a color image by providing a color filter for each pixel at the same time as providing a liquid crystal shutter for each pixel, and displays the color image by causing light which is emitted from a white backlight light source provided to the rear thereof to be selectively transmitted by the liquid crystal shutter and the color filter, however, it has a problem in that it requires a micro-fabrication process for high definition. This is because three pixels should be provided corresponding to the three colors of color filter R (red), G (green), and B (blue) for each pixel.

In order to solve this problem, in a display device such as a single-plate color projector, a so-called field sequential method is used in which irradiation light beams of three colors of RGB are sequentially generated using a rotating disk color filter, and an image of three colors is sequentially generated by modulating emission light in pixels using liquid crystals, or an MEMS (Micro Electro Mechanical System) shutter, however, it is known that, in this filter sequential method, a color break-up phenomenon occurs in which three colors of RGB are viewed subject to color separation when displaying a moving image.

A technology of an emission control is disclosed in JP8-248381A and JP2002-223453A in which a color break-up phenomenon can be avoided by causing the three colors of RGB to be emitted in a different order from each other in each one frame, in a display device which performs display using a field sequential method.

### SUMMARY OF THE INVENTION

It is known that human beings usually perceive a video which moves while repeatedly flickering as a video which smoothly moves on a screen. This is called apparent motion, and is used in technologies such as animation. In addition, human vision has a maximum sensitivity with respect to light with a wavelength in the vicinity of 550 nm, which corresponds to the color green G (green) color.

FIG. 22 is a diagram which shows a light emission time and a position on a screen of each color when a white rectangle which moves in the X direction with uniform velocity using an emission control in the related art is displayed. As shown in the drawing, when the three colors of RGB are displayed in different orders, human vision perceives the video as if it were moving like an arrow which connects the colors G shown in FIG. 22. As a result, the viewer of the image feels as if the video is blurred every three frames, and is unable to perceive smooth motion.

The present invention has been made in view of the circumstances described above, and an object thereof is to provide a display device using a field sequential method in which, without color break-up occurring, a video which smoothly moves can be perceived as is as smooth motion.

According to an aspect of the invention, there is provided a display device using a field sequential method including, a light source which independently emits light of plural principal wavelengths which are different from each other, and an emission control unit which controls emitting light having one principal wavelength among the plural wavelengths which are different from each other to be continuously emitted to the light source, in each sub-frame as plural time intervals in one frame period which is a display period of one screen, in which the emission control unit causes first principal wavelength light as one of the plural principal wavelengths, and which has a wavelength belonging to green light to be emitted in the sub-frame which is disposed at a same position in the one frame period of both an odd frame as the odd-numbered one frame period and an even frame as the even-numbered one frame period, and in which a second principal wavelength light which is principal wavelength light as one of the plural principal wavelengths, and is different from the first principal wavelength light is caused to be emitted in the sub-frame which is disposed at a different position in the one frame period between the odd frame and the even frame.

In addition, in the display device according to the aspect of the invention, the emission control unit may cause the second principal wavelength light to be emitted in the initial sub-frame of the odd frame, and may cause the same second principal wavelength light to be emitted in the last sub-frame of the even frame. In addition, the second principal wavelength light may be red or blue.

In addition, in the display device according to the aspect of the invention, the one frame period may have the plural sub-frames of principal wavelength light of same color.

In addition, in the display device according to the aspect of the invention, the one frame period may have three or more sub-frames of principal wavelength light of same color, and in which a length of the sub-frame adjacent to the center of the frame may be longer than a length of the sub-frame adjacent to the end of the frame.

In addition, in the display device according to the aspect of the invention, in the one frame period, a number of sub-frames of the principal wavelength belonging to the blue may be smaller than a number of sub-frames of the principal wavelength belonging to other colors.

In addition, the display device according to the aspect of the invention further includes, a display panel which has an optical shutter which performs any one of blocking and transmission of light from the light source for each pixel, and a display control unit which controls an operation of the optical shutter, in which the display control unit may perform a display of luminance corresponding to a grayscale value, by controlling the operation of the optical shutter at the timing of leading edge and trailing edge of each bit time, which is assigned to the frame, as the time interval corresponding to the luminance of each bit of the grayscale value.

In addition, in the display device according to the aspect of the invention, in a sub-frame in which three or more bit times relating to same principal wavelength light are continuously arranged, the bit time corresponding to a bit with high luminance in grayscale value may be arranged adjacent to the center of the sub-frame, and the bit time corresponding to a bit with low luminance may be arranged adjacent to the end of the sub-frame.

In addition, in the display device according to the aspect of the invention, the optical shutter may be configured with a Micro Electro Mechanical System (MEMS).

In addition, in the display device according to the aspect of the invention, the optical shutter may depend on an orientation of liquid crystals composition.

In addition, in the display device according to the aspect of the invention, the emission control unit may control a third principal wavelength light as one of the plural principal wavelengths, and which is different from the first principal wavelength light and second principal wavelength light, to be emitted in the sub-frame which is arranged at a same position in one frame period of the odd frames and the even frames.

In addition, in the display device according to the aspect of the invention, the third principal wavelength light may be white, or yellow.

According to the aspect of the invention, by using the field sequential method, the color break-up does not occur, and it is possible to make a viewer perceive as is a video which smoothly moves as smooth motion.

### BRIEF DESCRIPTION OF THE DRAWINGS

FIG. 1 is a diagram which shows a system configuration of an image display device according to a first embodiment.

FIG. 2 is a diagram which shows a configuration of a display panel in FIG. 1.

FIG. 3 is a diagram which shows a configuration of a pixel in FIG. 2.

FIG. 4 is a diagram which shows an emission control of a backlight light source for each color of RGB in an odd frame and an even frame.

FIG. 5 is a diagram which shows a light emission time and a position on a screen of each color in a case where a white rectangle which moves in the X direction with a uniform velocity is displayed using the emission control according to the first embodiment.

FIG. 6 is a diagram which describes the emission control in FIG. 4 more specifically, and shows an order in which light emission corresponding to bits which show each grayscale value of each color with respect to the odd frames and the even frames is performed.

FIG. 7 is a diagram which schematically shows a light emission time corresponding to luminance of each bit of the grayscale value.

FIG. 8 is a diagram which displays an appearance of color separation when displaying a white ellipse which moves in the right direction with respect to a black background.

FIG. 9 is a diagram which shows a configuration of a display panel according to a second embodiment.

FIG. 10 is a diagram which shows a configuration of a pixel in FIG. 9.

FIG. 11 is a diagram which shows an emission control of an image display device according to a third embodiment.

FIG. 12 is a diagram which shows an emission control of an image display device according to a fourth embodiment.

FIG. 13 is a diagram which shows an emission control of an image display device according to a fifth embodiment.

FIG. 14 is a table which shows marks denoting a luminance bit in a grayscale value in each color in FIG. 13.

FIG. 15 is a diagram which shows an emission control of an image display device according to a sixth embodiment.

FIG. 16 is a table which shows marks denoting a luminance bit in a grayscale value in each color in FIG. 15.

FIG. 17 is a diagram which shows an emission control of an image display device according to a seventh embodiment.

FIG. 18 is a diagram which shows an emission control of an image display device according to an eighth embodiment.

FIG. 19 is a diagram which shows an emission control of an image display device according to a ninth embodiment.

FIG. 20 is a diagram which shows an emission control of an image display device according to a tenth embodiment.

FIG. 21 is a diagram which shows an emission control of an image display device according to an eleventh embodiment.

FIG. 22 is a diagram which shows a light emission time and a position on a screen of each color in a case where a white rectangle which moves in the X direction with uniform velocity is displayed using the emission control in the related art.

### DETAILED DESCRIPTION OF THE INVENTION

Hereinafter, embodiments according to the invention will be described while referring to drawings. In addition, in the drawings, similar or identical elements will be given the same reference numerals, and description thereof will be omitted.

### First Embodiment

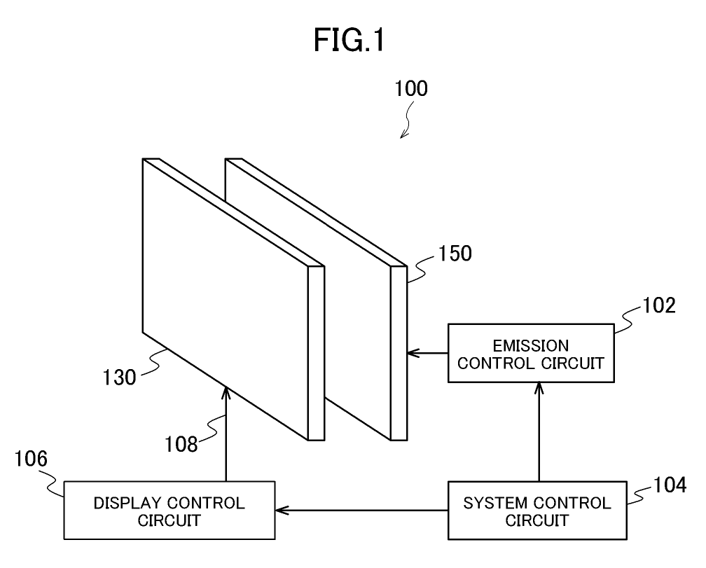

A configuration and operations of a first embodiment of the invention will be sequentially described using FIGS. 1 to 6.

FIG. 1 is a configuration diagram of a system of an image display device 100 according to the first embodiment. As shown in FIG. 1, a system control circuit 104 is connected to a display control circuit 106 and an emission control circuit 102, the display control circuit 106 is connected to a display panel 130 through a panel control line 108, and the emission control circuit 102 is connected to a backlight light source 150. The system control circuit 104 of the image display device 100 transmits image data corresponding to a display image and a driving timing of the display panel 130 to the display control circuit 106, and transmits a timing of causing the backlight light source 150 to emit light any one of three colors of RGB by being synchronized with the driving of the display panel 130 to the emission control circuit 102. When receiving these signals, the display control circuit 106 and emission control circuit 102 respectively transmit the signals which are necessary for driving the display panel 130 and the backlight light source 150 to the display panel 130 and the backlight light source 150.

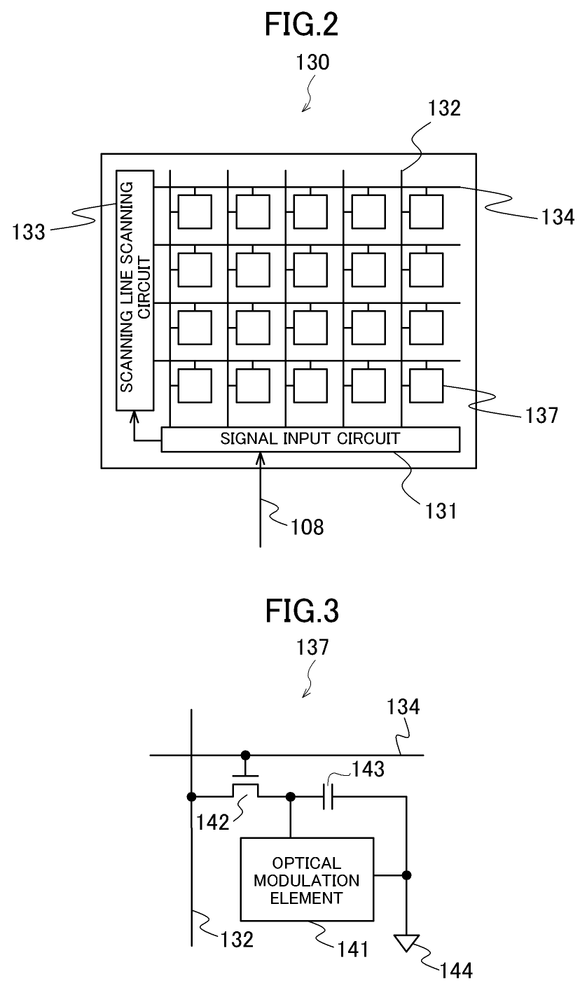

FIG. 2 is a diagram which shows a configuration of the display panel 130 in FIG. 1. Pixels 137 are arranged in a matrix in a display area of the display panel 130, scanning lines 134 are connected to the pixels 137 in the row direction, and signal line 132 are connected thereto in the column direction. A scanning line scanning circuit 133 is connected to one end of the scanning line 134, and a signal input circuit 131 is provided at one end of the signal line 132. In addition, the signal input circuit 131 controls the scanning line scanning circuit 133, and the panel control line 108 is input to the signal input circuit 131. When image data and a driving timing are input to the display panel 130 from the panel control line 108, the signal input circuit 131 inputs digital image data to the signal line 132 while controlling the scanning line scanning circuit 133 at a predetermined timing. Operations of each of the pixels 137 are controlled by the scanning line scanning circuit 133 by the scanning line 134, and each pixel captures the digital image data from the signal line 132 at a predetermined timing.

FIG. 3 shows a configuration of the pixel 137 in FIG. 2. A gate of the pixel 137 is connected to the scanning line 134, and the pixel is configured by a TFT (Thin Film Transistor) switch 142 of which one end of a drain-source terminal is connected to the signal line 132, a signal holding capacitance 143 which is provided between the other end of the drain-source terminal of the TFT switch 142 and a common electrode 144, and an optical modulation element 141 which is connected to both ends of the signal holding capacitance 143. When the TFT switch 142 of the pixel 137 which is selected by the scanning line 134 is in the on-state, a high voltage, or a low voltage as the digital image data which is written in the signal line 132 is written in the signal holding capacitance 143, and the image data is held even after the scanning line 134 turns the TFT switch 142 off. The high voltage, or the low voltage which is written in the signal holding capacitance 143 is input to the optical modulation element 141, and due to the voltage, the optical modulation element 141 controls whether or not to perform shading with respect to the backlight light source 150. Here, switching on and off of the optical modulation element 141 is subject to a binary control, however, it is possible to perform an 8-bit grayscale display by performing a Pulse Width Modulation (PWM) of a light emission period in each bit, by a bit weight of the digital image data. In addition, the optical modulation element 141 is formed using an optical shutter in which a so-called MEMS technology is adopted, and a detailed structure and a grayscale display operation thereof are described in the above described JP8-248381A and JP2002-223453A. Here, each pixel 137 does not have color separation means such as a color filter, and in the embodiment, color developing is controlled using a so-called field sequential method in which the luminous color of the backlight light source 150 is sequentially changed.

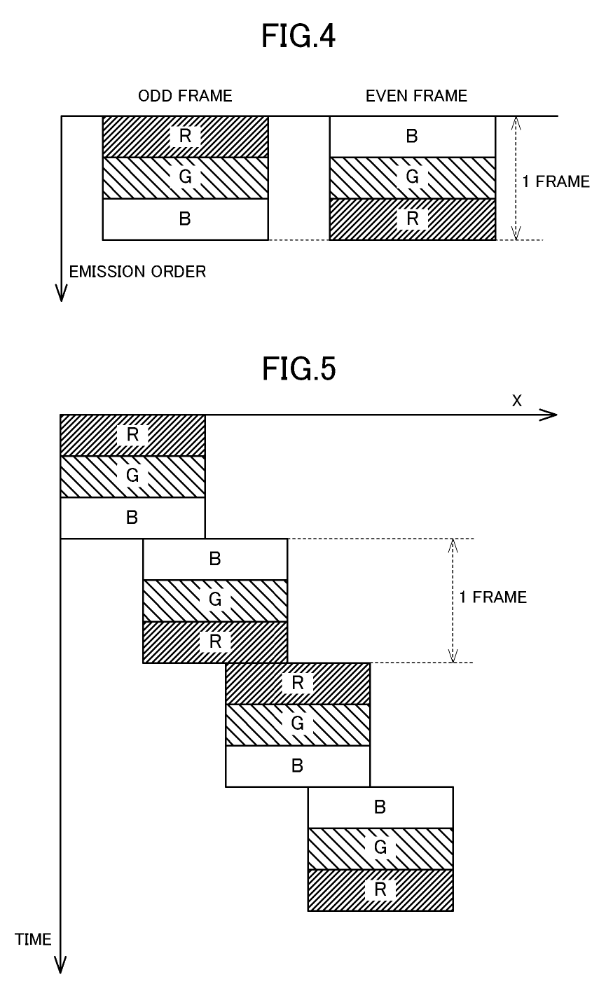

FIG. 4 is a diagram which shows the emission control of each color of RGB in the odd frames and the even frames of the backlight light source 150 according to the embodiment. As shown in FIG. 4, the emission control circuit 102 performs a display of one screen by causing the backlight light source 150 to emit light of three colors of RGB in each frame period of 1/60 secs, however, in the odd frame as an odd numbered frame period, the R color is emitted in the first sub-frame, the B color is emitted in the third sub-frame, the B color is emitted in the first sub-frame, and the R color is emitted in the third sub-frame, in the even frame as an even numbered frame period. In addition, the G color is emitted in the second sub-frame at all times. Here, as shown in FIG. 4, sub-frame means a period in which one color among each of the colors of the backlight light source 150 is continuously emitted.

FIG. 5 is a diagram which shows a display of a state where the emission control according to the embodiment is adopted. In FIG. 5, the horizontal axis denotes the X-coordinate on a screen, and the vertical axis denotes the time axis. A state in which a rectangle video expressed in white is moving in the X direction is displayed. As shown in the drawing, it has advantages in which it is possible to display the motions of the G color, which is largely visible to a human being, smoothly, since the position of the sub-frame of G color in each frame period is not changed due to the emission control in FIG. 4, and at the same time, it is possible to mitigate coloring which occurs in front of and to the rear of a moving image by equalizing the coloring with the Mg (magenta) color of which the visibility is low, since the R color and B color which emit before and after the G color are switched in each frame.

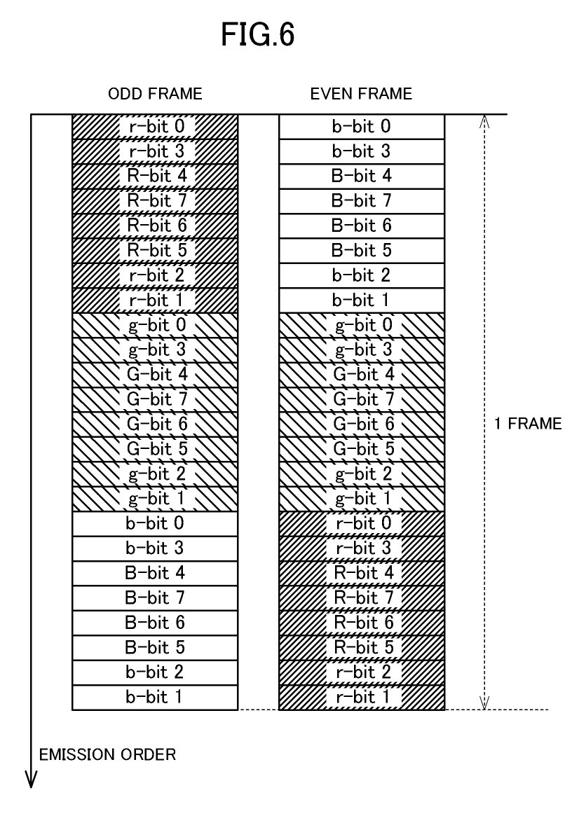

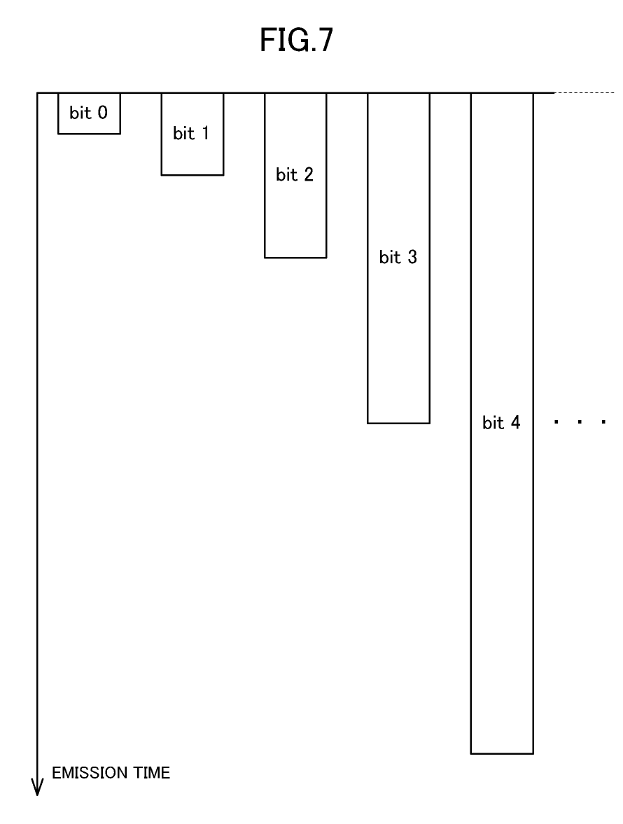

FIG. 6 is a diagram which describes the emission control in FIG. 4 more specifically, and shows an order in which light emission corresponding to bits denoting each grayscale value of each color with respect to the odd frame and even frame is performed. Here, R-bit 7 means the MSB (Most Significant Bit) of an 8-bit signal of the R color, and r-bit 0 means the LSB (Least Significant Bit) of the R color. In addition, for ease of understanding, these are classified such that the capital letter R corresponds to large bit signals of 4 to 7, and the small letter r corresponds to small signals of 0 to 3; accordingly, G and g, and B and b are also used by being divided for the same purpose. Here, FIG. 6 is a diagram which shows the emission order, not the emission time, and the emission times of each bit are not the same as each other. As shown in FIG. 7, the emission time of each bit is proportional to the magnitude of a value represented by the bit, the LSB bit is 0, and is the minimum value, and the MSB bit is 7, and is the maximum value. As shown in FIG. 6, in each color, high luminance bits are arranged at the center, and low luminance bits are arranged before and after the high luminance bits, however, this is for suppressing an occurrence of a Dynamic Fault Contour by not largely changing the light emission timing at the time of displaying each grayscale value.

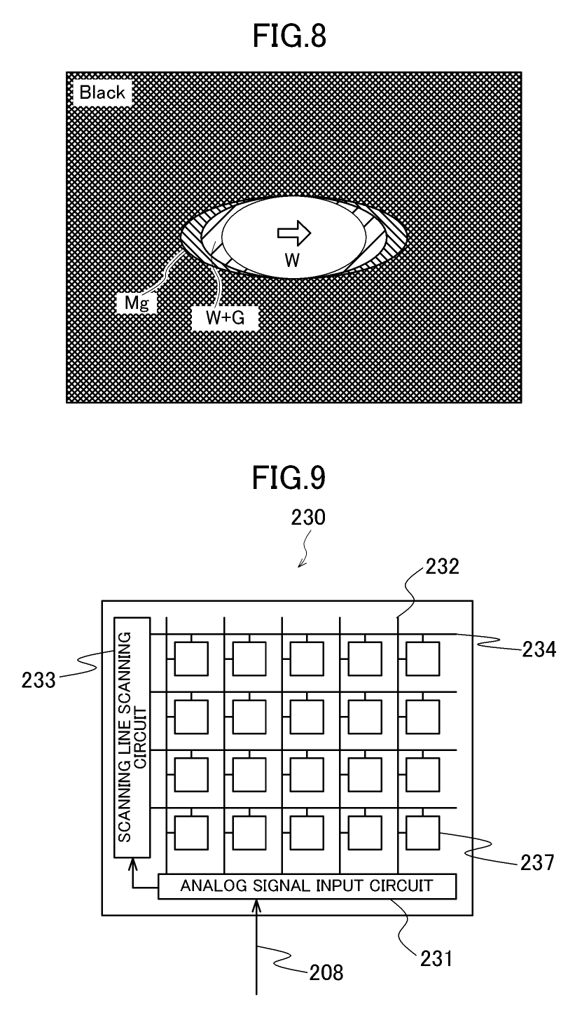

FIG. 8 is a schematic view which shows an appearance of a color separation when displaying a W (white) ellipse which moves in the right direction with respect to a black background. The reason for displaying a white object with respect to a black background is to show one of the screens in which the color separation is the most perceivable. According to the embodiment, a contour of a Mg color occurs in front of and to the rear of the white moving object, however, a color region of (W+G) is generated between the white object and the contour of the Mg color. The Mg color has low visibility, and the G color is not perceivable by being mixed with the white color. In addition, according to the embodiment, it is advantageous that the color separation is perceived almost as an achromatic color, since the Mg color and the W+G color are visually mixed by approaching each other, in addition to an advantage that the color separation is not changed in front of and to the rear of the object in the movement direction.

In addition, according to the embodiment, the pixels 137 which are configured in the TFT circuit provided on a glass substrate are driven by the signal input circuit 131 and the scanning line scanning circuit 133 which are configured by a silicon LSI (Large Scale Integration), however, the application of the invention is not limited to such a configuration. Even when these circuit components are integrally configured by a TFT on a single insulating transparent substrate, or are realized as a single crystal Si element on a SOI (Silicon on Insulator) substrate including the pixel, it is clear that the purpose of the invention can be applicable within a range not departing from the spirit of the invention. In addition, according to the embodiment, the 8-bit display is exemplified, however, 6 bits, or other bits may be easily applicable within a range not departing from the spirit of the invention.

### Second Embodiment

Hereinafter, an image display device according to a second embodiment of the invention will be described. In addition, the entire system configuration of the image display device according to the second embodiment has the same configuration as that shown in FIG. 1 in the first embodiment, accordingly, descriptions thereof will be omitted.

FIG. 9 shows a configuration of a display panel 230 according to the second embodiment. Pixels 237 are arranged in a matrix in a display area of the display panel 230, and scanning lines 234 are connected to the pixels 237 in the row direction, and signal lines 232 are connected thereto in the column direction. A scanning line scanning circuit 233 is connected to one end of the scanning line 234, and an analog signal input circuit 231 is provided at one end of the signal line 232. In addition, the analog signal input circuit 231 controls the scanning line scanning circuit 233, and a panel control line 208 is input to the analog signal input circuit 231.

When image data and a driving timing are input to the display panel 230 from the panel control line 208, the analog signal input circuit 231 inputs analog image data to the signal line 232 while controlling the scanning line scanning circuit 233 at a predetermined timing. Operations of each pixel 237 are controlled from the scanning line scanning circuit 233 by the scanning line 234, and the analog image data is captured from the signal line 232 at a predetermined timing.

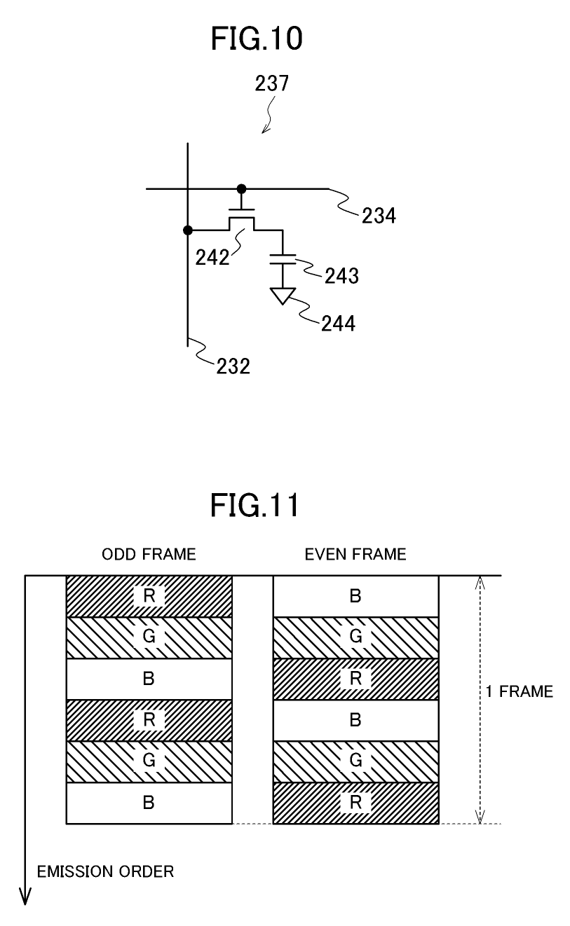

A configuration of the pixel 237 is shown in FIG. 10. A gate of the pixel 237 is connected to the scanning line 234, and the pixel is configured by a TFT switch 242 of which one end of a drain-source terminal is connected to the signal line 232, and a liquid crystal capacitive element 243 which is provided between the other end of the drain-source terminal of the TFT switch 242 and a common electrode 244.

When the TFT switch 242 of the pixel 237 which is selected by the scanning line 234 is on-state, a signal voltage as analog image data which is written in the signal line 232 is written in the liquid crystal capacitive element 243, and is held even after the TFT switch 242 is turned off by the scanning line 234. The liquid crystal capacitive element 243 performs an analog control of the light shielding amount with respect to a backlight light source 150 using the signal voltage which is written in the liquid crystal capacitive element 243. In addition, regarding the analog control of the light shielding amount with respect to the backlight light source 150 by the liquid crystal capacitive element 243, since it has the same operating principles as those of a general liquid crystal display which is commercially available, detailed descriptions thereof will be omitted here.

Here, the pixel 237 does not have color separation means such as a color filter, and according to the second embodiment, color development is controlled using a so-called field sequential method in which the luminous color of the backlight light source 150 is sequentially changed. In addition, the emission control in the second embodiment is the same as that in the first embodiment which is described using FIGS. 4 to 6, and descriptions thereof will be omitted.

Similarly to the first embodiment, even the second embodiment has an advantage that it is possible to display the motion of a G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color of which the visibility is low.

### Third Embodiment

Since an image display device according to a third embodiment has the same system configuration, the same display panel configuration, and the same pixel configuration as those in the first embodiment, descriptions thereof will be omitted. Each pixel in the third embodiment does not have color separation means such as a color filter, as well, and color development according to the embodiment is also controlled by a so-called field sequential method in which the luminous color of a backlight light source is sequentially changed.

FIG. 11 is a diagram which shows an emission control of the image display device according to the third embodiment. FIG. 11 shows an emission order of color which is emitted from the backlight light source by indicating time scale on the vertical axis with respect to an odd frame and an even frame.

Three colors of RGB are emitted twice in order in a frame period of 1/60 secs, however, the emission order of the R color at this time is the first and fourth sub-frames, and the B color is emitted in the third and sixth sub-frames in the odd frame. On the contrary, the emission order in the even frame is the third and sixth sub-frames for the R color, and the first and fourth sub-frames for the B color. In addition, the G color is emitted in the second and fifth sub-frames at all times.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the first embodiment, since the lighting timing of a pixel in which, for example, only the R color is emitted is set to roughly once in 1/30 secs, there is a problem of flickering being easily perceived. However, according to the third embodiment, there is an advantage in that flickering is not perceived since the lighting timing is once or more in 1/60 secs, even in such a case.

A digital driving method according to the third embodiment has the same 8-bit arrangement as that in the first embodiment in each emission timing of each color, and has basically the same configuration as that in the first embodiment, excepting that one frame in FIG. 4 is repeated twice; accordingly, descriptions thereof will be omitted.

### Fourth Embodiment

Since an image display device according to a fourth embodiment has the same system configuration, the same display panel configuration, and the same pixel configuration as those in the above described first embodiment, descriptions thereof will be omitted. Each pixel in the fourth embodiment does not have a color separation means such as a color filter, as well, and color development according to the embodiment is also controlled by a so-called field sequential method in which the luminous color of a backlight light source is sequentially changed.

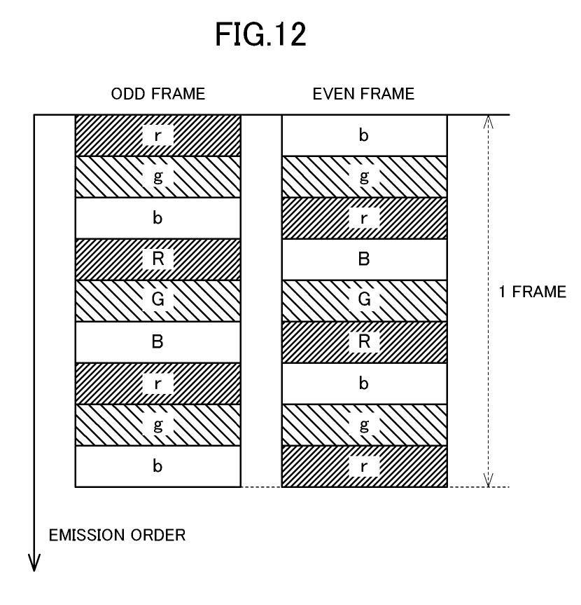

FIG. 12 is a diagram which shows an emission control of the image display device according to a fourth embodiment. In FIG. 12, the emission order of colors emitted by a backlight light source is shown by indicating time scale on the vertical axis with respect to an odd frame and an even frame.

Three colors of RGB are emitted three times in order in a frame period of 1/60 secs, however, the emission order of the R color is the first, fourth, and the seventh sub-frames, and the B color is emitted in the third, sixth, and ninth sub-frames in the odd frame. On the contrary, the emission order in the even frame is the third, sixth, and ninth sub-frames for the R color, and the first, fourth, and seventh sub-frames for the B color. In addition, the G color is emitted in the second, fifth, and eighth sub-frames at all times.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the first embodiment, since a lighting timing of a pixel in which, for example, only the R color is emitted is set to roughly once in 1/30 secs, there is a problem of flickering being easily perceived. However, according to the fourth embodiment, there is an advantage in that flickering is not perceived since the lighting timing is once or more in 1/60 secs, even in such a case.

In addition, capital letters R, G, and B, the marks in FIG. 12 denote high luminance bits from 4 bits to 7 bits, and small letters r, g, and b denote low luminance bits from 0 bit to 3 bits, accordingly, the high luminance and the low luminance are displayed by being divided. Here, since the small letters r, g, and b are displayed twice in one frame, the emission period for each time is set to ½, and the luminance thereof is adjusted. That is, the second sub-frame of each color which is arranged adjacent to the center of each frame period is the sub-frame of high luminance bits, and, as shown in FIG. 7, is set to be longer than the first and third sub-frames of low luminance bits of each color which are arranged adjacent to the end of each frame period.

Since the same color are emitted twice with the same luminance in one frame period, in the third embodiment described in FIG. 11, there is a problem of double reflection easily occurring with respect to a moving image. However, according to the embodiment, since the high luminance bits emit only once in one frame period, there is an advantage in that the double reflection with respect to the moving image does not easily occur.

In addition, according to the embodiment, the emission period per time of the small letters r, g, and b is set to ½, and each the luminance is adjusted in order to display the small letters r, g, and b twice in one frame, however, it is also possible to make the ratio of the first emission luminance to the second emission luminance, that is, it is possible to differentiate the ratio of emission period while keeping the sum of the first and the second emission periods for the small letters r, g and b constant. For example, when the first emission period is set to ¼, it is possible to set the second emission period to ¾. In this manner, since it is also possible to make a distribution of emission including low luminance bits on the time axis narrower, the image quality with respect to the moving image can be further improved.

### Fifth Embodiment

Since an image display device according to a fifth embodiment has the same system configuration, the same display panel configuration, and the same pixel configuration as those in the first embodiment, descriptions thereof will be omitted. Each pixel in the fifth embodiment does not have color separation means such as a color filter, as well, and color development according to the embodiment is also controlled by a so-called field sequential method in which the luminous color of a backlight light source is sequentially changed.

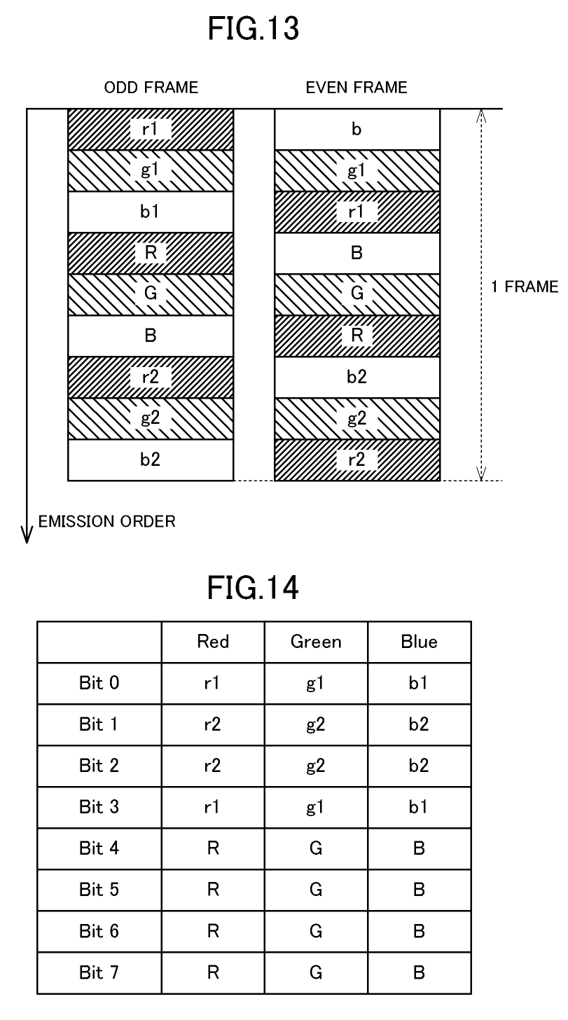

FIG. 13 is a diagram which shows an emission control of the image display device according to the fifth embodiment. In FIG. 13, the emission order of colors emitted by a backlight light source is shown by indicating time scale on the vertical axis with respect to an odd frame and an even frame.

Three colors of RGB are emitted three times in order in one frame period of 1/60 secs, however, the emission order of the R color is the first, fourth, and the seventh sub-frames, and the B color is emitted in the third, sixth, and ninth sub-frames in the odd frame. On the contrary, the emission order in the even frame is the third, sixth, and ninth sub-frames for the R color, and the first, fourth, and seventh sub-frames for the B color. In addition, the G color is emitted in the second, fifth, and eighth sub-frames at all times. In addition, in FIG. 14, marks denoting luminance bits in the grayscale value of each color in FIG. 13 are shown. As shown in FIG. 14, the marks R, G, and B in FIG. 13 denote high luminance bits from 4 bits to 7 bits of the respective R, G, and B colors, r1, g1, and b1 denote low luminance bits of 0 bit and 3 bits of the respective R, G, and B colors, and r2, g2, and b2 denote low luminance bits of 1 bit and 2 bits of the respective R, G, and B colors. That is, the second sub-frames of each color which are arranged adjacent to the center in each frame period are the sub-frames of high luminance bits, and, as shown in FIG. 13, are set to be longer than the first and third sub-frames of low luminance bits in each color which are arranged adjacent to the end of each frame period.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the first embodiment, since a lighting timing of a pixel in which, for example, only the R color is emitted is set to roughly once in 1/30 secs, there is a problem of flickering being easily perceived. However, according to the fifth embodiment, there is an advantage in that flickering is not perceived since the lighting timing is once or more in 1/60 secs, even in such a case.

Since the same color is emitted twice with the same luminance in one frame period, in the third embodiment described in FIG. 11, there is a problem of double reflection easily occurring with respect to a moving image. However, according to the embodiment, since the high luminance bits emit only once in one frame period, there is an advantage in that the double reflection with respect to the moving image does not easily occur. In addition, as described above, according to the embodiment, it is possible to avoid an increase in the number of writing in pixels in one frame period, since the low luminance bits are divided into two groups, and the high luminance bits are divided, as well, accordingly, digital data of these three groups can be displayed by being separated in one frame period.

### Sixth Embodiment

Since an image display device according to a sixth embodiment has the same system configuration, the same display panel configuration, and the same pixel configuration as those in the first embodiment, descriptions thereof will be omitted. Each pixel in the sixth embodiment does not have color separation means such as a color filter, as well, and color development according to the embodiment is also controlled by a so-called field sequential method in which the luminous color of a backlight light source is sequentially changed.

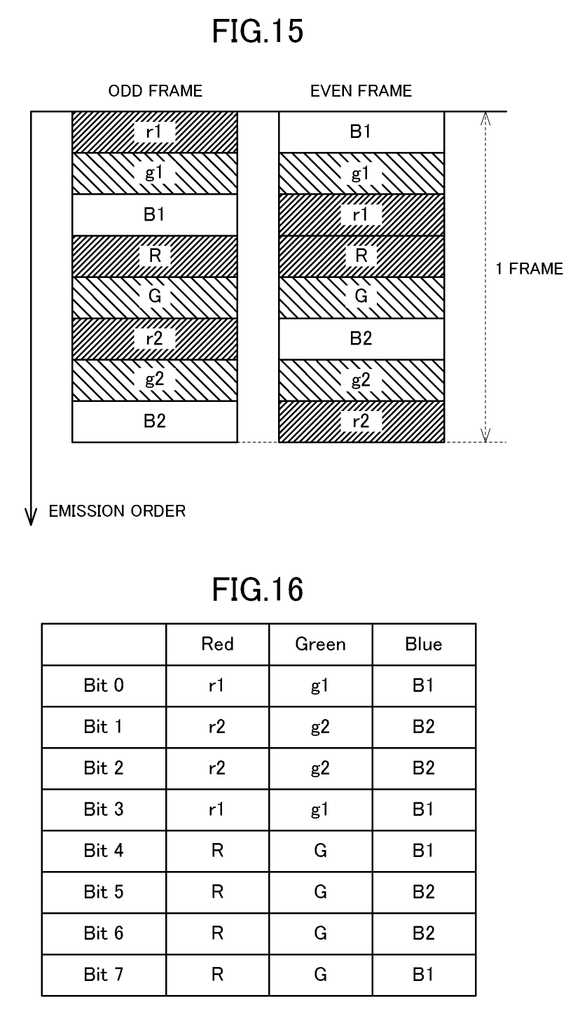

FIG. 15 is a diagram which shows an emission control of the image display device according to the sixth embodiment. In FIG. 15, the emission order of colors emitted by a backlight light source is shown by indicating time scale on the vertical axis with respect to an odd frame and an even frame.

Three colors of RGB are emitted three times in order in one frame period of 1/60 secs, however, the emission order of the R color is the first, fourth, and the sixth sub-frames, and the B color is emitted in the third and eighth sub-frames in the odd frame. On the contrary, the emission order in the even frame is the third, fourth, and eighth sub-frames for the R color, and the first and sixth sub-frames for the B color. In addition, the G color is emitted in the second, fifth, and seventh sub-frames at all times. In addition, in FIG. 16, marks denoting luminance bits in the grayscale value of each color in FIG. 15 are shown. As shown in FIG. 16, the marks R and G in FIG. 15 denote high luminance bits from 4 bits to 7 bits of the respective R and G colors, r1, and g1 denote low luminance bits of 0 bit and 3 bits of the respective R and G colors, and r2, and g2 denote low luminance bits of 1 bit and 2 bits of the respective R and G colors. In addition, B1 denotes bits of 0, 3, 4, and 7 of the B color, and B2 denotes bits of 1, 2, 5, and 6 thereof. That is, the second sub-frames of each color of the R color and the G color which are arranged adjacent to the center in each frame period are the sub-frames of high luminance bits, and, as shown in FIG. 15, are set to be longer than the first and third sub-frames of low luminance bits in each color of the R color and the G color which are arranged adjacent to the end of each frame period.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the first embodiment, since a lighting timing of a pixel in which, for example, only the R color is emitted is set to roughly once in 1/30 secs, there is a problem of flickering being easily perceived. However, according to the fifth embodiment, there is an advantage in that flickering is not perceived since the lighting timing is once or more in 1/60 secs, even in such a case.

Since the same color are emitted twice with the same luminance in one frame period, in the third embodiment described in FIG. 11, there is a problem of double reflection easily occurring with respect to a moving image. However, according to the embodiment, since the high luminance bits emit only once in one frame period, there is an advantage in that the double reflection with respect to the moving image does not easily occur. In addition, as described above, according to the embodiment, it is possible to avoid an increase in the number of writing in pixels in one frame period, since the R color and G color are divided into the low luminance bits and the high luminance bits, and the low luminance bits are divided into two groups, accordingly, digital data of these three groups can be displayed by being separated in one frame period.

In addition, according to the embodiment, the number of emission times of the B color is reduced compared to the R color and G color. This is because flickering or double reflection is difficult to perceive, since the visibility of the B color is relatively low. Accordingly, in this manner, it is possible to obtain effects such as luminance enhancement, or reduction in power consumption by reducing the number of switching times of the backlight light source 150.

### Seventh Embodiment

Since an image display device according to a seventh embodiment has the same system configuration, the same display panel configuration, and the same pixel configuration as those in the first embodiment, descriptions thereof will be omitted. Each pixel in the seventh embodiment does not have color separation means such as a color filter, as well, and color development according to the embodiment is also controlled by a so-called field sequential method in which the luminous color of a backlight light source is sequentially changed.

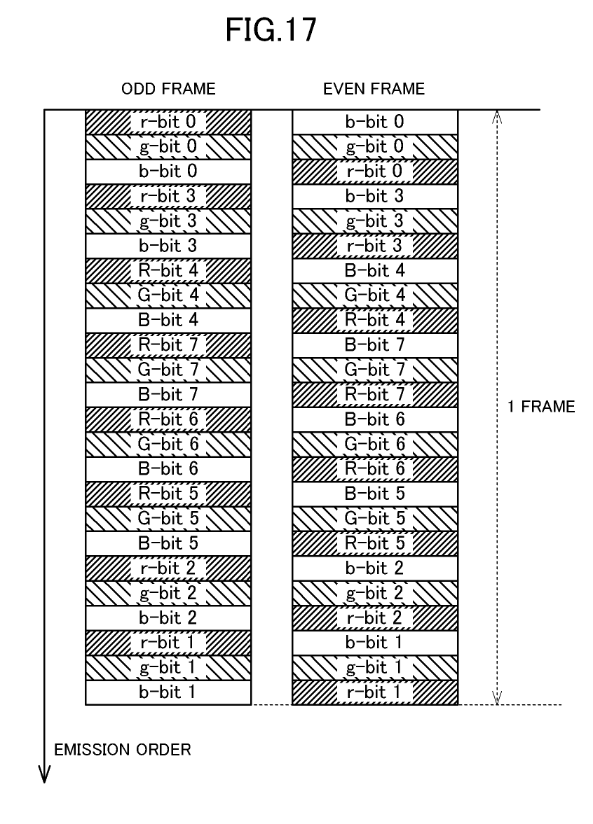

FIG. 17 is a diagram which shows an emission control of the image display device according to the seventh embodiment. In FIG. 17, the emission order of colors emitted by a backlight light source is shown by indicating time scale on the vertical axis with respect to an odd frame and an even frame. As shown in FIG. 17, according to the embodiment, three colors of RGB are emitted in each bit, however, the emission order in the odd frame is the R, G, and B colors, and the emission order in the even frame is the B, G, and R colors.

R-bit 7 means the MSB of an 8-bit signal of the R color, and r-bit 0 means the LSB of the R color. In addition, for ease of understanding, these are classified such that the capital letter R corresponds to large bit signals of 4 to 7, and the small letter r corresponds to small bit signals of 0 to 3, accordingly, G and g, and B and b are also used by being divided for the same purpose. As shown in FIG. 17, the fourth and fifth sub-frames of each color which are arranged adjacent to the center in each frame period are the sub-frames which emit bits 7 and 6 of high luminance, and the emission period thereof is set to be longer than the first, second, seventh, and eighth sub-frames of low luminance bits 0, 3, 2, and 1 which are arranged adjacent to the end of each frame period.

Here, the high luminance bits are arranged at the center, and low luminance bits are arranged in front of and to the rear thereof. It is to suppress an occurrence of a Dynamic Fault Contour, by making the emission timing at the time of displaying each grayscale not change significantly.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the embodiment, the configuration is one in which the amount of occurrence of color separation is less, since each color is switched in each sub-frame. In addition, there is an advantage in that flickering does not easily occur even when a single color is displayed.

### Eighth Embodiment

Since an image display device according to an eighth embodiment has the same system configuration, the same display panel configuration, and the same pixel configuration as those in the first embodiment, descriptions thereof will be omitted. Each pixel in the eighth embodiment does not have color separation means such as a color filter, as well, and color development according to the embodiment is also controlled by a so-called field sequential method in which the luminous color of a backlight light source is sequentially changed.

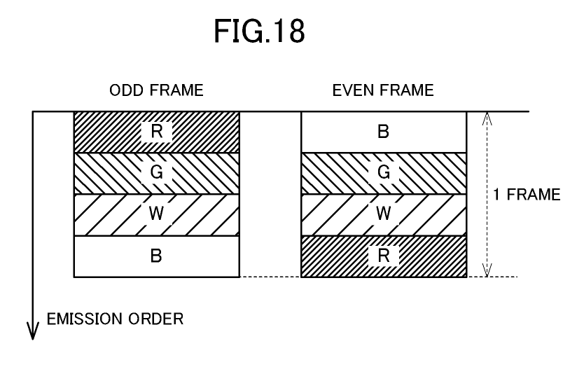

FIG. 18 is a diagram which shows an emission control of the image display device according to the eighth embodiment. In FIG. 18, the emission order of colors emitted by a backlight light source is shown by indicating time scale on the vertical axis with respect to an odd frame and an even frame.

Four colors of RGWB are emitted in one frame period of 1/60 secs, however, in the emission order thereof, the R color is emitted in the first sub-frame, and the B color is emitted in the fourth sub-frame in the odd frame. On the contrary, the emission order in the even frame is the fourth sub-frame for the R color, and the first sub-frame for the B color. In addition, the G color and the W color are emitted in the second and third sub-frames, respectively, at all times.

In this manner, according to the embodiment, there is an advantage in that it is possible to display the motion of the G color and W color which are largely visible to a human being, smoothly. At the same time, since the R color and the B color which are emitted just before and just after the G color and the W color are switched in each frame, it is possible to mitigate coloring which occurs in front of and to the rear of a moving image, by equalizing the coloring with the Mg color, the visibility of which is low.

In addition, since the W color is used in the eighth embodiment, there is an advantage in that it is possible to realize high luminance of a display of which purity is low. The W color is used in the embodiment, however, it is possible to use the Y (yellow) color, or other color, in addition to that.

### Ninth Embodiment

Since an image display device according to a ninth embodiment has the same system configuration, the same display panel configuration, and the same pixel configuration as those in the first embodiment, descriptions thereof will be omitted. Each pixel in the ninth embodiment does not have color separation means such as a color filter, as well, and color development according to the embodiment is also controlled by a so-called field sequential method in which the luminous color of a backlight light source is sequentially changed.

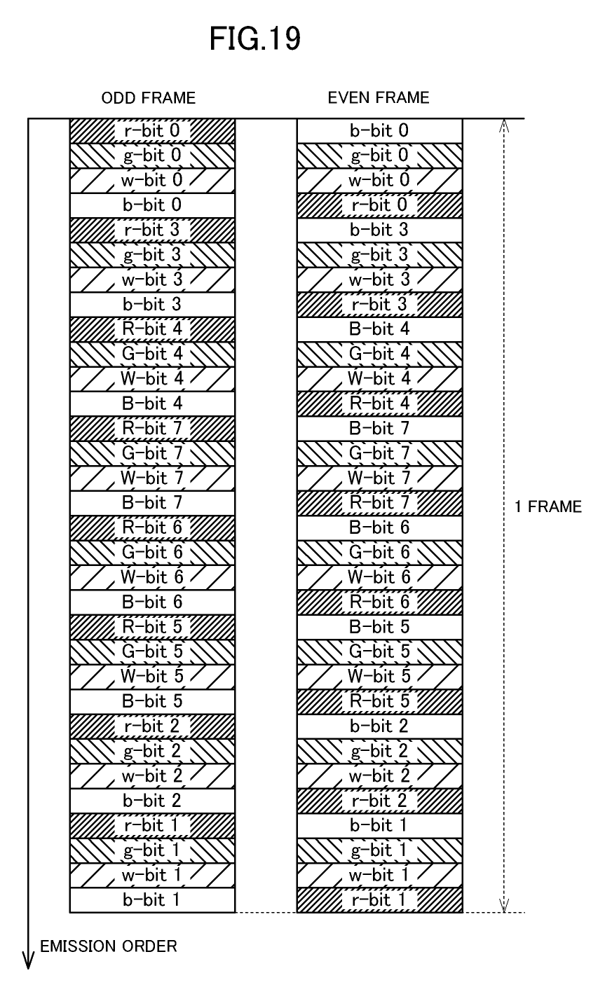

FIG. 19 is a diagram which shows an emission control of the image display device according to the ninth embodiment. In FIG. 19, the emission order of colors emitted by a backlight light source is shown by indicating time scale on the vertical axis with respect to an odd frame and an even frame. According to the embodiment, four colors of RGWB are emitted in each bit, however, the emission order in the odd frame is the R, G, W, and B colors, and the emission order in the even frame is the B, G, W, and R colors.

In the figure, R-bit 7 means the MSB of an 8-bit signal of the R color, and r-bit 0 means the LSB of the R color. In addition, for ease of understanding, these are classified such that the capital letter R corresponds to large bit signals of 4 to 7, and the r corresponds to small bit signals of 0 to 3, accordingly, G and g, B and b, and W and w are also used by being divided for the same purpose. As shown in FIG. 19, the fourth and fifth sub-frames of each color which are arranged adjacent to the center in each frame period are the sub-frames which emit bits 7 and 6 of high luminance, and the emission period thereof is set to be longer than the first, second, seventh, and eighth sub-frames of low luminance bits 0, 3, 2, and 1 which are arranged adjacent to the end of each frame period. Here, the high luminance bits are arranged at the center, and low luminance bits are arranged in front of and to the rear thereof. It is to suppress an occurrence of a Dynamic Fault Contour, by making the emission timing at the time of displaying each grayscale not change significantly.

In this manner, according to the embodiment, there is an advantage in that it is possible to display the motion of the G color and W color, which are largely visible to a human being, smoothly. At the same time, since the R color and the B color which are emitted just before and just after the G color and the W color are switched in each frame, it is possible to mitigate coloring which occurs in front of and to the rear of a moving image, by equalizing the coloring with the Mg color, the visibility of which is low.

In addition, according to the embodiment, the configuration is one in which the amount of occurrence of color separation is less, since each color is switched in each sub-frame. In addition, similarly to the seventh embodiment which is described using FIG. 17, there is an advantage in that flickering does not easily occur even when a single color is displayed.

### Tenth Embodiment

Since an image display device according to a tenth embodiment has the same system configuration, the same display panel configuration, and the same pixel configuration as those in the first embodiment, descriptions thereof will be omitted. Each pixel in the tenth embodiment does not have color separation means such as a color filter, as well, and color development according to the embodiment is also controlled by a so-called field sequential method in which the luminous color of a backlight light source is sequentially changed.

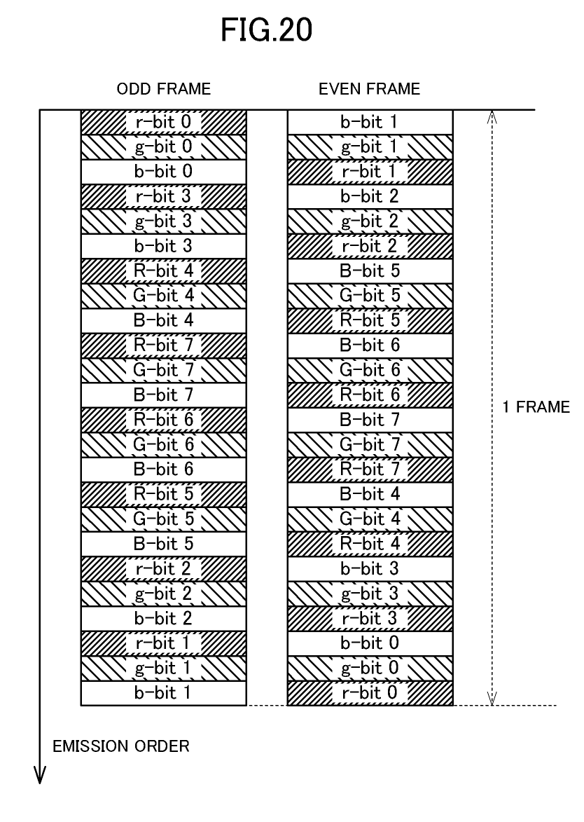

FIG. 20 is a diagram which shows an emission control of the image display device according to the tenth embodiment. In FIG. 20, the emission order of colors emitted by a backlight light source is shown by indicating time scale on the vertical axis with respect to an odd frame and an even frame. According to the embodiment, three colors of RGB are emitted in each bit, however, the emission order in the odd frame is the R, G, and B colors, and the emission order in the even frame is the B, G, and R colors.

In the figure, R-bit 7 means the MSB of an 8-bit signal of the R color, and r-bit 0 means the LSB of the R color. In addition, for ease of understanding, these are classified such that the capital letter R corresponds to large bit signals of 4 to 7, and the r corresponds to small bit signals of 0 to 3, accordingly, G and g, and B and b are also used by being divided for the same purpose. As shown in FIG. 20, the fourth and fifth sub-frames of each color which are arranged adjacent to the center in each frame period are the sub-frames which emit bits 7 and 6 of high luminance, and the emission period thereof is set to be longer than the first, second, seventh, and eighth sub-frames of low luminance bits 0, 3, 2, and 1 which are arranged adjacent to the end of each frame period.

Here, the high luminance bits are arranged at the center, and low luminance bits are arranged in front of and to the rear thereof. It is to suppress an occurrence of a Dynamic Fault Contour, by making the emission timing at the time of displaying each grayscale not change significantly.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low.

In addition, according to the embodiment, the configuration is one in which the amount of occurrence of color separation is less, since each color is switched in each sub-frame. In addition, there is an advantage in that flickering does not easily occur even when a single color is displayed.

In addition, according to the embodiment, the emission is performed in the order of bits 0, 3, 4, 7, 6, 5, 2, and 1, in an odd frame, and is performed in the opposite order in an even frame. In this manner, averaging of the Dynamic Fault Contour which occurs in the odd and even frames is aimed, and according to the embodiment, it is possible to further achieve an effect of suppressing the Dynamic Fault Contour.

### Eleventh Embodiment

Since an image display device according to an eleventh embodiment has the same system configuration, the same display panel configuration, and the same pixel configuration as those in the first embodiment, descriptions thereof will be omitted. Each pixel in the eleventh embodiment does not have color separation means such as a color filter, as well, and color development according to the embodiment is also controlled by a so-called field sequential method in which the luminous color of a backlight light source is sequentially changed.

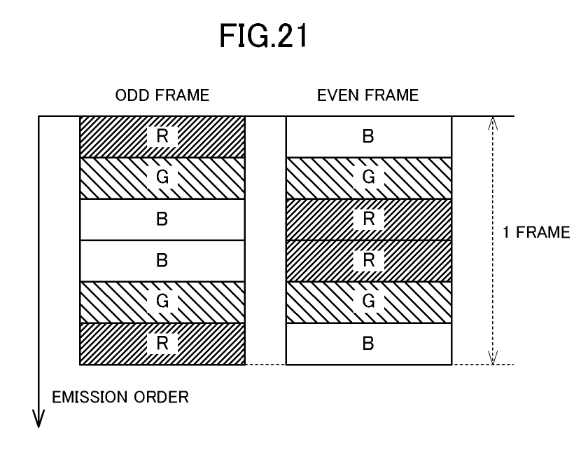

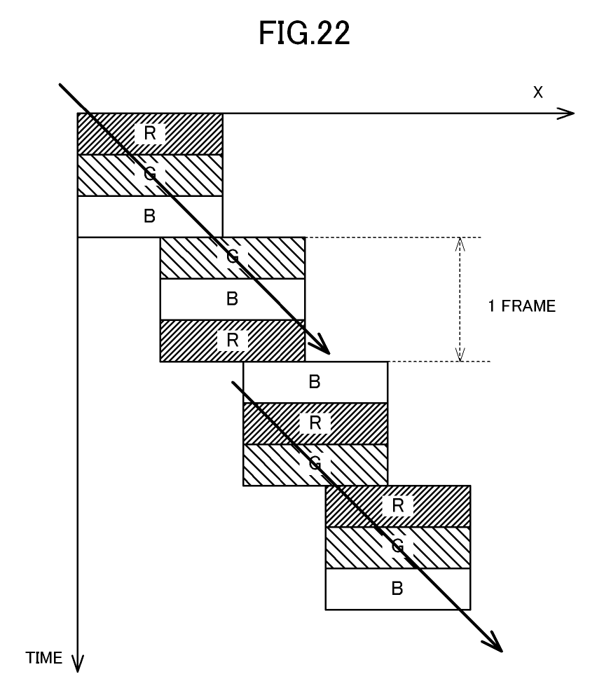

FIG. 21 is a diagram which shows an emission control of the image display device according to the eleventh embodiment. In FIG. 21, the emission order of colors emitted by a backlight light source is shown by indicating time scale on the vertical axis with respect to an odd frame and an even frame.

Three colors of RGB are emitted in one frame period of 1/60 secs, however, the emission order of the R color is the first and the sixth sub-frames, and the B color is emitted in the third and fourth sub-frames in the odd frame. On the contrary, the emission order in the even frame is the third, and fourth sub-frames for the R color, and the first and sixth sub-frames for the B color. In addition, the G color is emitted in the second and fifth sub-frames at all times.

In this manner, according to the embodiment, there is an advantage in that it is possible to display the motion of the G color, which is largely visible to a human being, smoothly. At the same time, since the R color and the B color which are emitted just before and just after the G color are switched in each frame, it is possible to mitigate coloring which occurs in front of and to the rear of a moving image, by equalizing the coloring with the Mg color, the visibility of which is low. It is similar to the third embodiment. According to the third embodiment, however, there is a problem in that an image easily becomes blurry since the emission of the R color and B color belonging to different frame signals is continued twice on the boundary of the frame, however, it is possible to solve such a problem in the eleventh embodiment.

In addition, according to the first embodiment, since a lighting timing of a pixel in which, for example, only the R color is emitted is set to roughly once in 1/30 secs, there is a problem of flickering being easily perceived. However, according to the embodiment, there is an advantage in that flickering is not perceived since the lighting timing is once or more in 1/60 secs, even in such a case.

A digital driving method according to the embodiment has the same 8-bit arrangement as that in the first embodiment in each emission timing of each color, and has basically the same configuration as that in the first embodiment, excepting that one frame in FIG. 4 is repeated twice, accordingly, descriptions thereof will be omitted.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device using a field sequential method comprising:
a light source which independently emits light of a plurality of principal wavelengths which are different from each other; and
an emission control unit which controls emitting light having one principal wavelength among the plurality of principal wavelengths which are different from each other to be continuously emitted from the light source, in each sub-frame as a plurality of time intervals in one frame period which is a display period of one screen,
wherein the emission control unit causes first principal wavelength light as one of the plurality of principal wavelengths, which has a wavelength belonging to green light to be emitted in the sub-frame which is disposed at a same position in the one frame period of both an odd frame as the odd-numbered one frame period and an even frame as the even-numbered one frame period, and
wherein a second principal wavelength light which is principal wavelength light as one of the plurality of principal wavelengths, and is different from the first principal wavelength light is caused to be emitted in the sub-frame which is arranged at a different position in the one frame period between the odd frame and the even frame.

2. The display device of the field sequential method according to claim 1,
wherein the emission control unit causes the second principal wavelength light to be emitted in the initial sub-frame of the odd frame, and causes the same second principal wavelength light to be emitted in the last sub-frame of the even frame.

3. The display device of the field sequential method according to claim 1,
wherein the second principal wavelength light is red, or blue.

4. The display device of the field sequential method according to claim 1,
wherein the one frame period has the plurality of sub-frames of principal wavelength light of same color.

5. The display device of the field sequential method according to claim 1,
wherein the one frame period has three or more sub-frames of principal wavelength light of same color, and in which a length of the sub-frame adjacent to the center of the frame is longer than a length of the sub-frame adjacent to the end of the frame.

6. The display device of the field sequential method according to claim 1,
wherein, in the one frame period, a number of sub-frames of the principal wavelength belonging to blue is smaller than a number of sub-frames of the principal wavelength belonging to other colors.

7. The display device of the field sequential method according to claim 1, further comprising:
a display panel which has an optical shutter which performs anyone of blocking and transmission of light from the light source for each pixel; and
a display control unit which controls an operation of the optical shutter,
wherein the display control unit performs a display of luminance corresponding to a grayscale value, by controlling the operation of the optical shutter at the timing of leading edge and trailing edge of each bit time, which is assigned to the frame, as the time interval corresponding to the luminance of each bit of the grayscale value.

8. The display device of the field sequential method according to claim 7,
wherein, in a sub-frame in which three or more bit times relating to same principal wavelength light are continuously arranged, the bit time corresponding to a bit with high luminance in grayscale value is arranged adjacent to the center of the sub-frame, and the bit time corresponding to a bit with low luminance is arranged adjacent to the end of the sub-frame.

9. The display device of the field sequential method according to claim 7,
wherein, the optical shutter is configured with a Micro Electro Mechanical System (MEMS).

10. The display device of the field sequential method according to claim 7,
wherein the optical shutter depends on an orientation of a liquid crystal composition.

11. The display device of the field sequential method according to claim 1,
wherein the emission control unit controls a third principal wavelength light as one of the plurality of principal wavelengths, and which is different from the first principal wavelength light and second principal wavelength light, to be emitted in the sub-frame which is arranged at a same position in one frame of the odd frames and the even frames.

12. The display device of the field sequential method according to claim 11,
wherein the third principal wavelength light is a white color, or a yellow color.
